(19) United States
(12) Patent Application Publication
(10) Pub. No.: US 2026/0075506 A1
(43) Pub. Date: Mar. 12, 2026

(54) TECHNIQUES FOR USING A UNIFIED INITIAL ACCESS PROCEDURE

(71) Applicant: Lenovo (United States) Inc., Morrisville, NC (US)

(72) Inventors: Karthikeyan Ganesan, Nauheim (DE); Hyejung Jung, Northbrook, IL (US); Ali Ramadan Ali, Kraiburg am Inn (DE); Ravi Kuchibhotla, Chicago, IL (US)

(21) Appl. No.: 19/221,120

(22) Filed: May 28, 2025

(51) Int. Cl. H04W 48/16; H04L 5/00; H04W 48/18

(52) U.S. Cl. CPC H04W 48/16; H04L 5/0051; H04W 48/18

(57) ABSTRACT

Various aspects of the present disclosure relate to techniques for using a unified initial access procedure. A network equipment (NE) is configured to configure, as part of an initial access procedure, a common channel that supports a plurality of device types and a device type common channel for a device type of the plurality of device types, wherein the plurality of device types comprises a first device type that supports mobile broadband (MBB) communication and a second device type that supports an internet of things (IoT) communication; transmit, in the common channel, a first portion of remaining minimum system information (RMSI) that is common for the plurality of device types; and transmit, in the device type common channel, a second portion of the RMSI and paging information that is specific to the device type.

### TECHNICAL FIELD

The present disclosure relates to wireless communications, and more specifically to techniques for using a unified initial access procedure.

### BACKGROUND

A wireless communications system may include one or multiple network communication devices, which may be otherwise known as network equipment (NE), supporting wireless communications for one or multiple user communication devices, which may be otherwise known as user equipment (UE), or other suitable terminology. The wireless communications system may support wireless communications with one or multiple user communication devices by utilizing resources of the wireless communication system (e.g., time resources (e.g., symbols, slots, subframes, frames, or the like) or frequency resources (e.g., subcarriers, carriers, or the like)). Additionally, the wireless communications system may support wireless communications across various radio access technologies including third generation (3G) radio access technology, fourth generation (4G) radio access technology, fifth generation (5G) radio access technology, among other suitable radio access technologies beyond 5G (e.g., sixth generation (6G)).

### SUMMARY

An article “a” before an element is unrestricted and understood to refer to “at least one” of those elements or “one or more” of those elements. The terms “a,” “at least one,” “one or more,” and “at least one of one or more” may be interchangeable. As used herein, including in the claims, “or” as used in a list of items (e.g., a list of items prefaced by a phrase such as “at least one of” or “one or more of” or “one or both of) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.” Further, as used herein, including in the claims, a “set” may include one or more elements.

A UE for wireless communication is described. The UE may be configured to, capable of, or operable to receive, as part of an initial access procedure, configuration information comprising a common channel that supports a plurality of device types and a device type common channel for a device type of the plurality of device types, wherein the plurality of device types comprises a first device type that supports mobile broadband (MBB) communication and a second device type that supports an internet of things (IoT) communication, receive, in the common channel, a first portion of remaining minimum system information (RMSI) that is common for the plurality of device types, and receive, in the device type common channel, a second portion of the RMSI and paging information that is specific to the device type.

A processor for wireless communication is described. The processor may be configured to, capable of, or operable to receive, as part of an initial access procedure, configuration information comprising a common channel that supports a plurality of device types and a device type common channel for a device type of the plurality of device types, wherein the plurality of device types comprises a first device type that supports MBB communication and a second device type that supports an IoT communication, receive, in the common channel, a first portion of RMSI that is common for the plurality of device types, and receive, in the device type common channel, a second portion of the RMSI and paging information that is specific to the device type.

A method for wireless communication performed by a UE is described. The method may be configured to, capable of, or operable to receive, as part of an initial access procedure, configuration information comprising a common channel that supports a plurality of device types and a device type common channel for a device type of the plurality of device types, wherein the plurality of device types comprises a first device type that supports MBB communication and a second device type that supports an IoT communication, receive, in the common channel, a first portion of RMSI that is common for the plurality of device types, and receive, in the device type common channel, a second portion of the RMSI and paging information that is specific to the device type.

An NE for wireless communication is described. The NE may be configured to, capable of, or operable to configure, as part of an initial access procedure, a common channel that supports a plurality of device types and a device type common channel for a device type of the plurality of device types, wherein the plurality of device types comprises a first device type that supports MBB communication and a second device type that supports an IoT communication, transmit, in the common channel, a first portion of RMSI that is common for the plurality of device types, and transmit, in the device type common channel, a second portion of the RMSI and paging information that is specific to the device type.

A processor for wireless communication is described. The processor may be configured to, capable of, or operable to configure, as part of an initial access procedure, a common channel that supports a plurality of device types and a device type common channel for a device type of the plurality of device types, wherein the plurality of device types comprises a first device type that supports MBB communication and a second device type that supports an IoT communication, transmit, in the common channel, a first portion of RMSI that is common for the plurality of device types, and transmit, in the device type common channel, a second portion of the RMSI and paging information that is specific to the device type.

A method for wireless communication performed by a NE is described. The method may be configured to, capable of, or operable to configure, as part of an initial access procedure, a common channel that supports a plurality of device types and a device type common channel for a device type of the plurality of device types, wherein the plurality of device types comprises a first device type that supports MBB communication and a second device type that supports an IoT communication, transmit, in the common channel, a first portion of RMSI that is common for the plurality of device types, and transmit, in the device type common channel, a second portion of the RMSI and paging information that is specific to the device type.

### BRIEF DESCRIPTION OF THE DRAWINGS

FIG. 1 illustrates an example of a wireless communications system, in accordance with aspects of the present disclosure.

FIGS. 2A through 2C illustrate example initial access procedures for 6G mobile broadband (MBB) and low-power wide-area (LPWA), in accordance with aspects of the present disclosure.

FIG. 3 illustrates an example of physical broadcast channel (PBCH) repetition configuration, in accordance with aspects of the present disclosure.

FIG. 4A depicts an example of configuring separate parameter sets for basic coverage and extended coverage, in accordance with aspects of the present disclosure.

FIG. 4B depicts an example of an initial access procedure with a system information block 0 (SIB0) scheduled by PBCH, in accordance with aspects of the present disclosure.

FIG. 5 illustrates an example of a UE, in accordance with aspects of the present disclosure.

FIG. 6 illustrates an example of a processor, in accordance with aspects of the present disclosure.

FIG. 7 illustrates an example of an NE, in accordance with aspects of the present disclosure.

FIG. 8 illustrates a flowchart of a method performed by a UE, in accordance with aspects of the present disclosure.

FIG. 9 illustrates a flowchart of a method performed by an NE, in accordance with aspects of the present disclosure.

### DETAILED DESCRIPTION

Generally, the present disclosure describes systems, methods, and apparatuses for techniques for detecting anomalous policies in a virtualized network. In certain examples, the methods may be performed using computer-executable code embedded on a computer-readable medium. In certain examples, an apparatus or system may include a computer-readable medium containing computer-readable code which, when executed by a processor, causes the apparatus or system to perform at least a portion of the below described solutions.

In accordance with examples described herein, a wireless communication system (e.g., a 5G or 6G communication system) may have coverage for eMBB and LPWA. However, common channel communications (e.g., PBCH, SIB0, system information block type 1 (SIB1), paging, etc.) may need to be transmitted multiple times to meet the requirements for both eMBB and LPWA. Accordingly, communications on common channels may be inefficient, time consuming, power consuming, and resource consuming.

Given these disadvantages, the subject matter herein describes solutions that facilitate a reduction in resources needed to configure multiple types of communications. By having a uniform design for eMBB and LPWA UEs, a number of repetitions needed for configuring a UE may be reduced, thereby reducing power, time, and resources.

Aspects of the present disclosure are described in the context of a wireless communications system. Note that one or more aspects from different solutions may be combined.

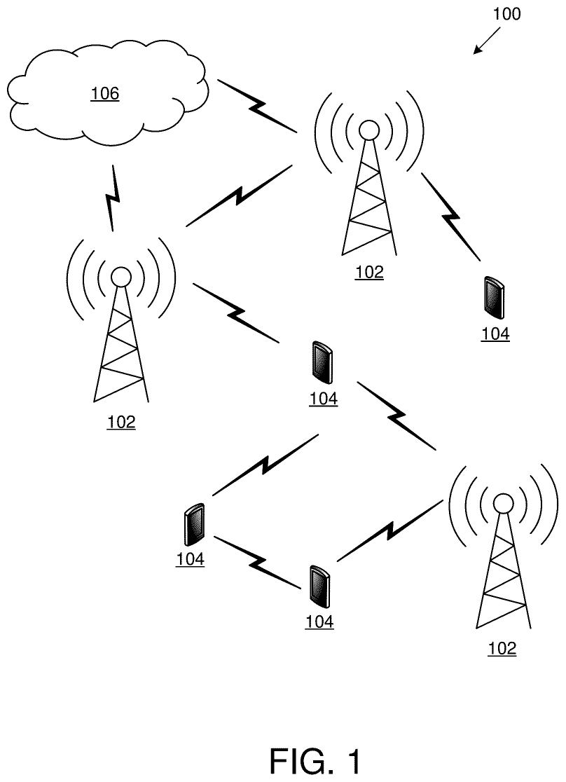

FIG. 1 illustrates an example of a wireless communications system 100 in accordance with aspects of the present disclosure. The wireless communications system 100 may include one or more NE 102, one or more UE 104, and a core network (CN) 106. The wireless communications system 100 may support various radio access technologies. In some implementations, the wireless communications system 100 may be a 4G network, such as a Long-Term Evolution (LTE) network or an LTE-Advanced (LTE-A) network. In some other implementations, the wireless communications system 100 may be a New Radio (NR) network, such as a 5G network, a 5G-Advanced (5G-A) network, or a 5G ultrawideband (5G-UWB) network. In other implementations, the wireless communications system 100 may be a combination of a 4G network and a 5G network, or other suitable radio access technology including Institute of Electrical and Electronics Engineers (IEEE) 802.11 (Wi-Fi), IEEE 802.16 (WiMAX), IEEE 802.20. The wireless communications system 100 may support radio access technologies beyond 5G, for example, 6G. Additionally, the wireless communications system 100 may support technologies, such as time division multiple access (TDMA), frequency division multiple access (FDMA), or code division multiple access (CDMA), etc.

The one or more NE 102 may be dispersed throughout a geographic region to form the wireless communications system 100. One or more of the NE 102 described herein may be or include or may be referred to as a network node, a base station, a network element, a network function, a network entity, a radio access network (RAN), a NodeB, an eNodeB (eNB), a next-generation NodeB (gNB), or other suitable terminology. An NE 102 and a UE 104 may communicate via a communication link, which may be a wireless or wired connection. For example, an NE 102 and a UE 104 may perform wireless communication (e.g., receive signaling, transmit signaling) over a Uu interface.

An NE 102 may provide a geographic coverage area for which the NE 102 may support services for one or more UEs 104 within the geographic coverage area. For example, an NE 102 and a UE 104 may support wireless communication of signals related to services (e.g., voice, video, packet data, messaging, broadcast, etc.) according to one or multiple radio access technologies. In some implementations, an NE 102 may be moveable, for example, a satellite associated with a non-terrestrial network (NTN). In some implementations, different geographic coverage areas associated with the same or different radio access technologies may overlap, but the different geographic coverage areas may be associated with different NE 102.

The one or more UE 104 may be dispersed throughout a geographic region of the wireless communications system 100. A UE 104 may include or may be referred to as a remote unit, a mobile device, a wireless device, a remote device, a subscriber device, a transmitter device, a receiver device, or some other suitable terminology. In some implementations, the UE 104 may be referred to as a unit, a station, a terminal, or a client, among other examples. Additionally, or alternatively, the UE 104 may be referred to as an Internet-of-Things (IoT) device, an Internet-of-Everything (IoE) device, or machine-type communication (MTC) device, among other examples.

A UE 104 may be able to support wireless communication directly with other UEs 104 over a communication link. For example, a UE 104 may support wireless communication directly with another UE 104 over a device-to-device (D2D) communication link. In some implementations, such as vehicle-to-vehicle (V2V) deployments, vehicle-to-everything (V2X) deployments, or cellular-V2X deployments, the communication link may be referred to as a sidelink. For example, a UE 104 may support wireless communication directly with another UE 104 over a PC5 interface.

An NE 102 may support communications with the CN 106, or with another NE 102, or both. For example, an NE 102 may interface with other NE 102 or the CN 106 through one or more backhaul links (e.g., S1, N2, N2, or network interface). In some implementations, the NE 102 may communicate with each other directly. In some other implementations, the NE 102 may communicate with each other or indirectly (e.g., via the CN 106). In some implementations, one or more NE 102 may include subcomponents, such as an access network entity, which may be an example of an access node controller (ANC). An ANC may communicate with the one or more UEs 104 through one or more other access network transmission entities, which may be referred to as a radio heads, smart radio heads, or transmission-reception points (TRPs).

The CN 106 may support user authentication, access authorization, tracking, connectivity, and other access, routing, or mobility functions. The CN 106 may be an evolved packet core (EPC), or a 5G core (5GC), which may include a control plane entity that manages access and mobility (e.g., a mobility management entity (MME), an access and mobility management functions (AMF)) and a user plane entity that routes packets or interconnects to external networks (e.g., a serving gateway (S-GW), a Packet Data Network (PDN) gateway (P-GW), or a user plane function (UPF)). In some implementations, the control plane entity may manage non-access stratum (NAS) functions, such as mobility, authentication, and bearer management (e.g., data bearers, signal bearers, etc.) for the one or more UEs 104 served by the one or more NE 102 associated with the CN 106.

The CN 106 may communicate with a packet data network over one or more backhaul links (e.g., via an S1, N2, N2, or another network interface). The packet data network may include an application server. In some implementations, one or more UEs 104 may communicate with the application server. A UE 104 may establish a session (e.g., a protocol data unit (PDU) session, or a PDN connection, or the like) with the CN 106 via an NE 102. The CN 106 may route traffic (e.g., control information, data, and the like) between the UE 104 and the application server using the established session (e.g., the established PDU session). The PDU session may be an example of a logical connection between the UE 104 and the CN 106 (e.g., one or more network functions of the CN 106).

In the wireless communications system 100, the NEs 102 and the UEs 104 may use resources of the wireless communications system 100 (e.g., time resources (e.g., symbols, slots, subframes, frames, or the like) or frequency resources (e.g., subcarriers, carriers)) to perform various operations (e.g., wireless communications). In some implementations, the NEs 102 and the UEs 104 may support different resource structures. For example, the NEs 102 and the UEs 104 may support different frame structures. In some implementations, such as in 4G, the NEs 102 and the UEs 104 may support a single frame structure. In some other implementations, such as in 5G and among other suitable radio access technologies, the NEs 102 and the UEs 104 may support various frame structures (i.e., multiple frame structures). The NEs 102 and the UEs 104 may support various frame structures based on one or more numerologies.

One or more numerologies may be supported in the wireless communications system 100, and a numerology may include a subcarrier spacing and a cyclic prefix. A first numerology (e.g., μ=0) may be associated with a first subcarrier spacing (e.g., 15 kHz) and a normal cyclic prefix. In some implementations, the first numerology (e.g., μ=0) associated with the first subcarrier spacing (e.g., 15 kHz) may utilize one slot per subframe. A second numerology (e.g., μ=1) may be associated with a second subcarrier spacing (e.g., 30 kHz) and a normal cyclic prefix. A third numerology (e.g., μ=2) may be associated with a third subcarrier spacing (e.g., 60 kHz) and a normal cyclic prefix or an extended cyclic prefix. A fourth numerology (e.g., μ=3) may be associated with a fourth subcarrier spacing (e.g., 120 kHz) and a normal cyclic prefix. A fifth numerology (e.g., μ=4) may be associated with a fifth subcarrier spacing (e.g., 240 kHz) and a normal cyclic prefix.

A time interval of a resource (e.g., a communication resource) may be organized according to frames (also referred to as radio frames). Each frame may have a duration, for example, a 10 millisecond (ms) duration. In some implementations, each frame may include multiple subframes. For example, each frame may include 10 subframes, and each subframe may have a duration, for example, a 1 ms duration. In some implementations, each frame may have the same duration. In some implementations, each subframe of a frame may have the same duration.

Additionally or alternatively, a time interval of a resource (e.g., a communication resource) may be organized according to slots. For example, a subframe may include a number (e.g., quantity) of slots. The number of slots in each subframe may also depend on the one or more numerologies supported in the wireless communications system 100. For instance, the first, second, third, fourth, and fifth numerologies (i.e., μ=0, μ=1, μ=2, μ=3, μ=4) associated with respective subcarrier spacings of 15 kHz, 30 kHz, 60 kHz, 120 kHz, and 240 kHz may utilize a single slot per subframe, two slots per subframe, four slots per subframe, eight slots per subframe, and 16 slots per subframe, respectively. Each slot may include a number (e.g., quantity) of symbols (e.g., orthogonal frequency division multiplexing (OFDM) symbols). In some implementations, the number (e.g., quantity) of slots for a subframe may depend on a numerology. For a normal cyclic prefix, a slot may include 14 symbols. For an extended cyclic prefix (e.g., applicable for 60 kHz subcarrier spacing), a slot may include 12 symbols. The relationship between the number of symbols per slot, the number of slots per subframe, and the number of slots per frame for a normal cyclic prefix and an extended cyclic prefix may depend on a numerology. It should be understood that reference to a first numerology (e.g., μ=0) associated with a first subcarrier spacing (e.g., 15 kHz) may be used interchangeably between subframes and slots.

In the wireless communications system 100, an electromagnetic (EM) spectrum may be split, based on frequency or wavelength, into various classes, frequency bands, frequency channels, etc. By way of example, the wireless communications system 100 may support one or multiple operating frequency bands, such as frequency range designations FR1 (410 MHz-7.125 GHz), FR2 (24.25 GHz-52.6 GHz), FR3 (7.125 GHZ-24.25 GHZ), FR4 (52.6 GHz-114.25 GHz), FR4a or FR4-1 (52.6 GHz-71 GHz), and FR5 (114.25 GHz-300 GHz). In some implementations, the NEs 102 and the UEs 104 may perform wireless communications over one or more of the operating frequency bands. In some implementations, FR1 may be used by the NEs 102 and the UEs 104, among other equipment or devices for cellular communications traffic (e.g., control information, data). In some implementations, FR2 may be used by the NEs 102 and the UEs 104, among other equipment or devices for short-range, high data rate capabilities.

FR1 may be associated with one or multiple numerologies (e.g., at least three numerologies). For example, FR1 may be associated with a first numerology (e.g., μ=0), which includes 15 kHz subcarrier spacing; a second numerology (e.g., μ=1), which includes 30 kHz subcarrier spacing; and a third numerology (e.g., μ=2), which includes 60 kHz subcarrier spacing. FR2 may be associated with one or multiple numerologies (e.g., at least 2 numerologies). For example, FR2 may be associated with a third numerology (e.g., μ=2), which includes 60 kHz subcarrier spacing; and a fourth numerology (e.g., μ=3), which includes 120 kHz subcarrier spacing.

In new radio (NR), a synchronization signal block (SSB) burst may span a duration of 5 ms, corresponding to half of a radio frame. The SSB burst may be transmitted in either the first or second half of the radio frame, with the selected half-frame being indicated in the master information block (MIB). While the default SSB periodicity for a UE performing initial access may be 20 ms, the actual periodicity may be indicated in the SIB1.

The maximum number of candidate SSB transmissions in NR may be determined based on the frequency range (FR) and subcarrier spacing (SCS). For frequency range 1 (FR1), the number of candidate SSBs may be up to 8, while for frequency range 2 (FR2), it may be up to 64.

The primary synchronization signal (PSS), secondary synchronization signal (SSS), and physical broadcast channel (PBCH) may be transmitted together in consecutive OFDM symbols.

Each SSB may occupy four OFDM symbols in the time domain and may span 240 subcarriers (equivalent to 20 resource blocks) in the frequency domain.

The PSS may be transmitted in the first OFDM symbol and may occupy 127 subcarriers.

The SSS may be transmitted in the third OFDM symbol and may also occupy 127 subcarriers. There may be eight unused subcarriers below the SSS and nine unused subcarriers above it.

The PBCH may span two full OFDM symbols-namely, the second and fourth-covering 240 subcarriers in each. Additionally, in the third OFDM symbol, the PBCH may occupy 48 subcarriers below and 48 subcarriers above the SSS. Accordingly, the PBCH may span a total of 576 subcarriers across three OFDM symbols (i.e., 240+48+48+240=576).

In some configurations, a reduced capability (RedCap) feature may be used for support for 3 MHz cells. A challenge that may arise is that an NR SSB design may be configured for 5 MHz channels, resulting in an SSB occupying 20 physical resource blocks (PRBs). Assuming a 15 kHz SCS, the SSB bandwidth may be approximately 3.6 MHz. To fit the SSB within a 3 MHz bandwidth, PBCH regions above and below the PSS/SSS may need to be punctured. This modification may result in performance and coverage degradation for RedCap devices as compared to certain UEs.

Conventionally, the PSS, SSS, and PBCH (e.g., SSBlock) may be transmitted together. In addition, a first control resources set (CORESET) (CORESET #0), which may include scheduling information for SIB1, may be transmitted with a default periodicity of 20 ms. When operating within a 3 MHz or 5 MHz bandwidth, the CORESET #0 and SIB1 resources may be punctured or restricted to accommodate bandwidth limitations.

A coverage enhancement level 0 may provide coverage equivalent to enhanced MBB (eMBB). Moreover, a coverage enhancement level 1 may provide an additional 10 dB of coverage, for example, through a repetition factor X. Further, a coverage enhancement level 2 may provide an additional 20 dB of coverage using a higher repetition factor Y, where Y>X.

To support extended coverage requirements for low-power wide-area (LPWA) devices, the cell may perform additional repetitions of common channels, such as the PBCH, SIB0, SIB1, and paging messages.

In configurations described herein, a uniform design may be used for both eMBB and LPWA UEs operating in 3 MHz and 5 MHz bandwidths. These configurations may support SSBs, CORESET #0, and SIB1 for both 15 kHz and 30 kHz SCS configurations to satisfy baseline coverage requirements. Additionally, a common channel structure may be used to reduce the number of repetitions while maintaining extended coverage capabilities.

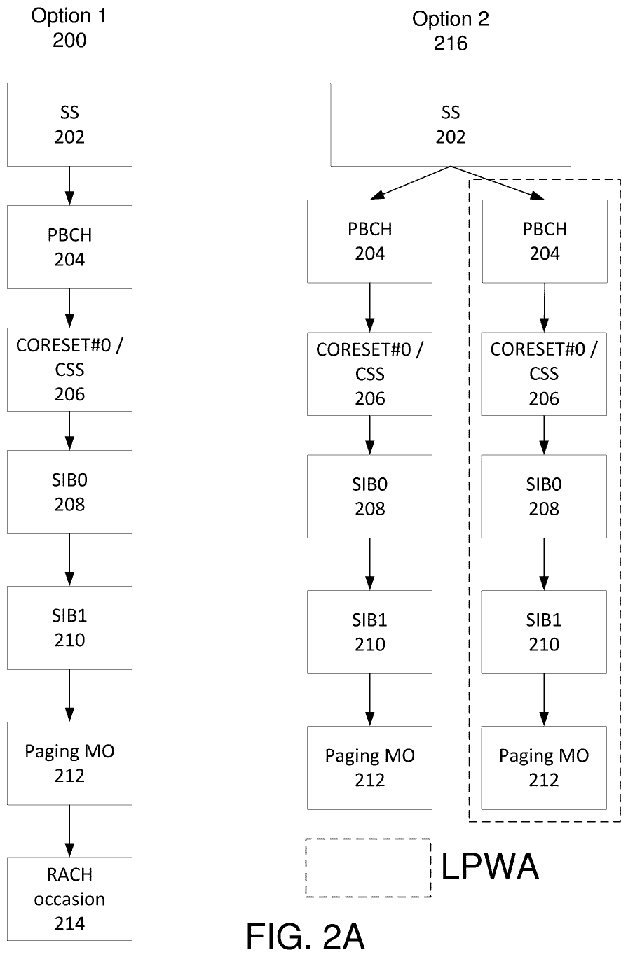

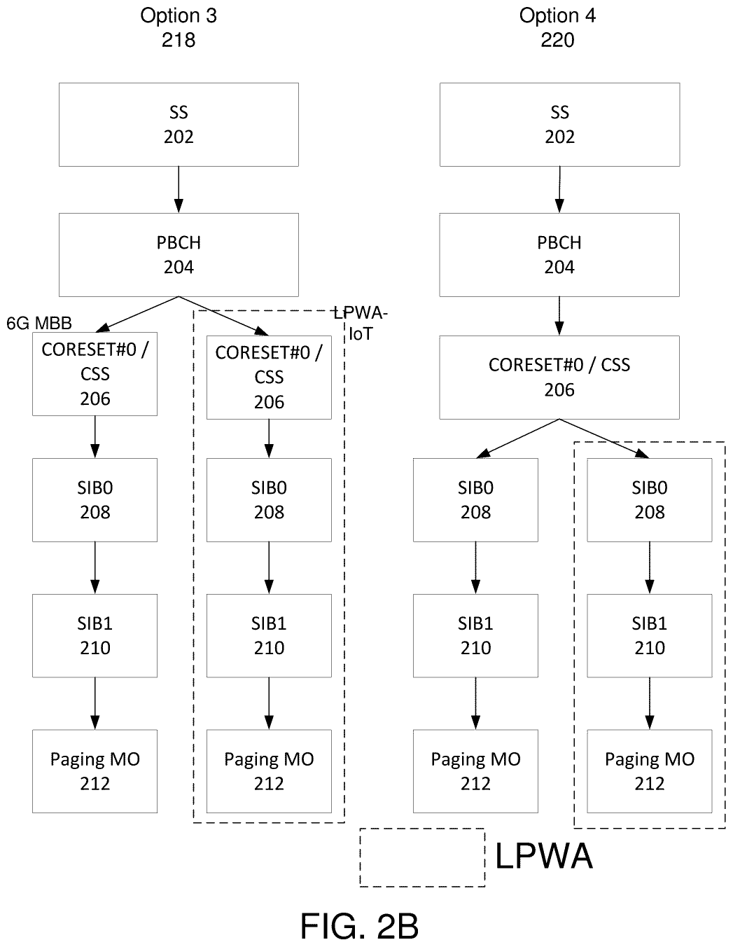

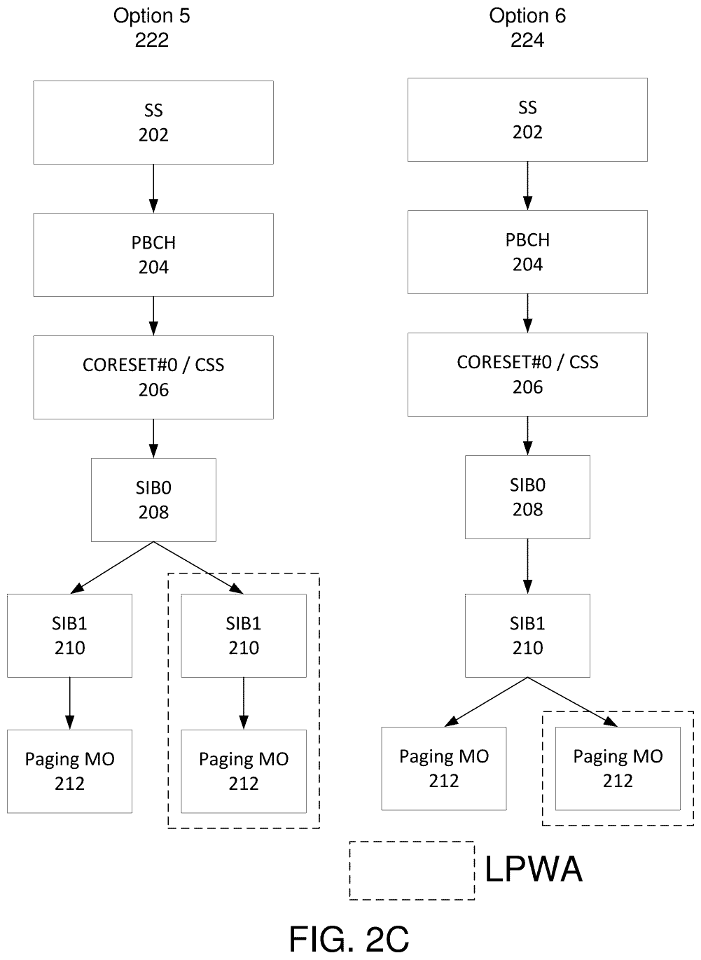

FIGS. 2A through 2C illustrate example initial access procedures for 6G MBB and LPWA, in accordance with aspects of the present disclosure. Option 1 200 includes a synchronization signal (SS) 202, PBCH 204, CORESET #0/common search space (CSS) 206, SIB0 208, SIB1 210, paging monitoring occasion (MO) 212, and random access channel (RACH) occasion 214. Option 2 216, Option 3 218, Option 4 220, Option 5 222, and Option 6 224 each contain similar elements to Option 1 200. In Option 2 216, a split from the SS 202 is for MBB on one side and LPWA on the other side.

The selection of one of the options illustrated in FIGS. 2A through 2C for a unified initial access procedure for 6G eMBB and 6G low-power wide-area internet of things (LPWA-IoT) may depend on various factors, including but not limited to the following: the basic coverage requirement for cMBB may be approximately 145 dB, while the deep coverage requirement for the common channel may be configured to meet a target maximum coupling loss (MCL) of 164 dB; the modification period of the common channel may vary between eMBB and LPWA configurations and may influence the initial access design; the reduced bandwidth requirements of LPWA-IoT devices may affect one or more aspects of the common channel design; enhanced power savings and extended battery life may be prioritized for LPWA-IoT devices in comparison to eMBB devices; LPWA-IoT applications may be delay-tolerant, unlike many eMBB use cases, thereby allowing for more flexible timing in channel design and data delivery; and/or a lean system information payload may be employed for LPWA-IoT devices due to the low bit rate supported at an MCL of 164 dB.

In Option 3 218, the SS and physical layer broadcast signal may be unified for 6G cMBB and LPWA-IoT devices. However, the CORESET #0, SIB0, SIB1, and paging monitoring occasions may be separately configured for each device type.

Most of the MIB content may be shared between 6G eMBB and LPWA-IoT devices. This shared content may include, but is not limited to, the following: cell barring; intra-frequency reselection; SSB-subcarrier offset, which may indicate the frequency domain offset between the SSB and the overall resource block grid in units of subcarriers; subcarrier spacing for common channels such as SIB1, message 2/4 for initial access, paging, and broadcast system information messages; and/or system frame number.

Additional content may be specifically configured for and read by LPWA-IoT devices within the MIB. For instance, the MIB may include the hyper frame number (HFN) (or a portion of the bits representing the HFN), which may be relevant due to the longer sleep cycles of LPWA-IoT devices compared to eMBB devices. This configuration may further depend on the modification period of subsequent RMSI transmissions in the system information, which may extend beyond the radio frame number of 1024.

Certain UE type-specific parameters may be separately configured for each device type. However, signaling overhead may be minimized by using the same row index across different configuration tables for the respective device types, as described herein.

These separately configurable parameters may include: the time-frequency location and size of CORESET #0; the monitoring occasion of the common search space within CORESET #0 for scheduling the remaining part of the required minimum system information (RMSI) during the first SIB; and/or the demodulation reference signal (DMRS) position for the first downlink (DL) transmission.

6G eMBB and LPWA-IoT devices may use separate tables that define values for CORESET #0 and CSS #0. Each row in these tables may include corresponding entries for CORESET #0 time-frequency location and common search space monitoring occasions.

In a first implementation, UEs may select different tables based on their configured device types. The base station may indicate the same row index in the MIB for both tables. Each row index may correspond to device-specific values for CORESET #0 time-frequency location and common search space monitoring occasions.

In a second implementation, the base station may include a separate field in the MIB to indicate the row index for each respective table, thereby providing device-type-specific CORESET #0 time-frequency location and monitoring occasion information.

The DMRS positions may be separately signaled for each device type, as the remaining portion of the RMSI associated with the first downlink transmission may be configured independently for LPWA-IoT and eMBB.

In a third implementation, one or more tables defining the time-frequency location of CORESET #0 and/or physical downlink control channel (PDCCH) monitoring occasions for RMSI delivery (i.e., a PDCCH common search space 0) may include two entries per row: a first entry for eMBB and a second entry for LPWA-IoT.

Table 1 illustrates one example of 6G MIB content.

TABLE 1
6G MIB Content

| | |
|---|---|
| Cell barring | 1 or 2 bits - 1 bit means unified barring for all device types |
| | 2 bit means one of the devices can be barred |
| | 01 - MBB barred, LPWA not barred |
| | 10 - LPWA barred, MBB not barred |
| | 00 - both devices barred |
| | 11 - both devices not barred |
| Intra-frequency | 1 or 2 bits - informing one or more devices to |
| reselection | select another cell |
| SSB-subcarrier offset | Number of subcarriers from reference point A of a carrier |
| subcarrier spacing | Subcarrier spacing used to receive other RMSI |
| common | |
| System frame number | Part of system frame |
| Hyper frame number | Part of HFN |
| CORESET#0 and CSS#0 | 8 bits - SIB#0 or SIB#1 scheduling information |
| DMRS position | 1 bit - DMRS position in first DL |

The selection of the modification period for a unified PBCH may take into account several considerations. These may include the additional repetitions required by LPWA-IoT user equipment to achieve the desired extended coverage range, and whether such repetitions can be accommodated within the selected modification period. Furthermore, power-saving requirements of LPWA-IoT devices may influence this selection, as a shorter modification period may result in more frequent wake-up cycles, thereby adversely affecting battery life.

Certain configurations may use a same modification period. In view of the foregoing design considerations, the modification period of the MIB may be conservatively selected and may be configured to be the same for both eMBB and LPWA-IoT devices. Within each MIB modification period, for example, eight to ten repetitions of the PBCH may be configured in order to satisfy the deep coverage requirements of LPWA-IoT devices. The modification period may be equal to, or an integer multiple of, the SSB periodicity. An LPWA-IoT device may be configured with default PBCH candidate locations and repetition periods to monitor these repetition.

A base number of PBCH repetitions (e.g., four) may be defined, with additional repetitions configured to enhance coverage for LPWA-IoT devices. These additional repetitions may be monitored exclusively by LPWA-IoT devices, whereas the base repetitions may be monitored by both eMBB and LPWA-IoT device types.

In one implementation, the periodicity of the SSB—comprising the synchronization signal and PBCH—may be 160 ms. Additional PBCH repetitions associated with a given SSB transmission may be performed within the same SSB periodic interval. For instance, each additional PBCH repetition may occur every 20 ms, resulting in eight PBCH repetitions within the 160 ms interval corresponding to a single SSB transmission or within a modification period of the MIB. The additional PBCH transmissions may be aligned with the same half-frame as the original SSB transmission. For example, if the SSB is transmitted in the first half of a radio frame, the associated PBCH repetitions may also occur in the first half-frame of subsequent radio frames. No additional PBCH repetitions may be transmitted if the associated SSB beam is not transmitted. In some implementations, the additional PBCH repetitions may be configured for all SSB beams, while in other implementations, the repetitions may be configured only for selected SSB beams.

In another implementation, each PBCH burst may be configured to occur every 20 ms. PBCH repetitions may be performed for each associated SSB beam index. The starting symbols of these additional PBCH repetition occasions within each PBCH burst may be configured using a formula similar to that used for SSB occasions, for example, {2, 8}+14n, where n=0, 1. The maximum number of additional PBCH bursts for performing PBCH repetitions may be defined as a default parameter.

The configuration of additional PBCH repetitions may be represented by an index pointing to a table that specifies the maximum number of additional PBCH bursts associated with a given SSB burst within a periodic interval. This table may also define the corresponding time locations, repetition periods, and related parameters. Such information may be signaled in the RMSI to enable idle-mode UEs to continue acquiring the PBCH during each MIB modification period.

In a second implementation, the PBCH configuration may follow a “repeat-first, beam-second” logic. According to this approach, the PBCH may be repeatedly transmitted on a first beam up to a maximum configured repetition count before beginning repetition on a second beam, and so forth. In scenarios involving selective transmission of PBCH repetitions on a per-beam basis, this implementation may offer improved efficiency and reduced cell wake-up frequency by grouping repetitions of each beam and transmitting them as a burst.

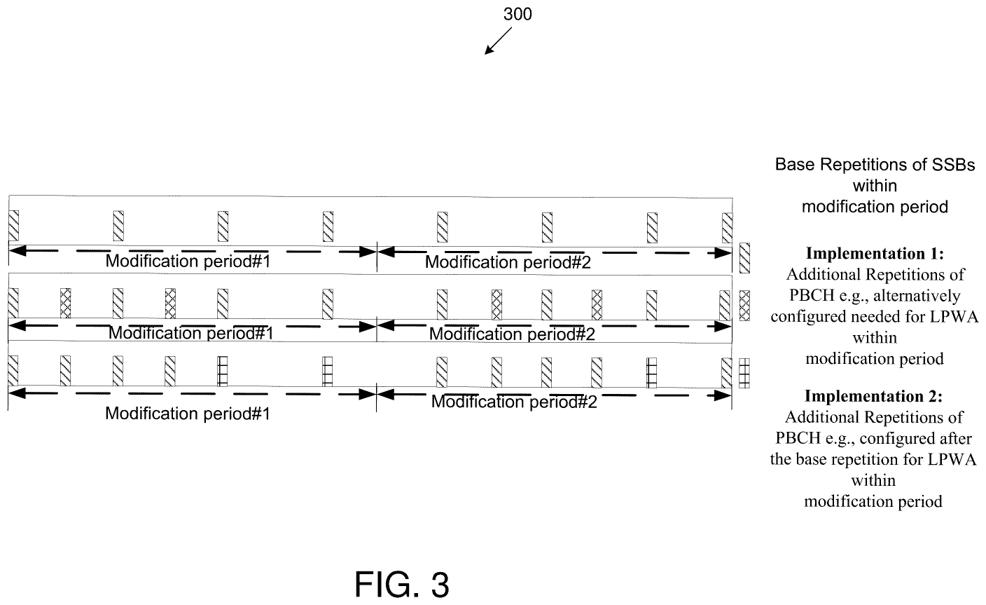

FIG. 3 illustrates an example of PBCH repetition configuration 300, in accordance with aspects of the present disclosure. In FIG. 3, a base repetition of SSBs within a modification period, a first implementation showing additional repetitions of PBCH, and a second implementation showing additional repetitions of PBCH are illustrated.

Each group of MIB content within a PBCH may be associated with a different modification period.

Typically, a single modification period is applied to the entire MIB content of a PBCH. However, in a unified design applicable to both eMBB and IoT devices—which may have differing operational characteristics—each group of MIB content within a PBCH may instead be associated with a distinct modification period. In such cases, a plurality of modification periods may be assigned to a single PBCH.

In some implementations, 6G MIB content may be categorized into: (i) common MIB content for both eMBB and IoT devices, (ii) MIB content specific to IoT devices, and (iii) MIB content specific to eMBB devices. For example, the common MIB content and IoT-specific MIB content may be associated with a first modification period, while the eMBB-specific MIB content may be associated with a second, shorter modification period. This configuration may prevent IoT devices from frequently re-acquiring MIB content and thereby reduce power consumption by allowing longer sleep cycles. Meanwhile, eMBB devices may benefit from the shorter modification period, which may enable the broadcast of updated MIB content in response to varying UE density within a cell.

In an alternative implementation, MIB content that changes more frequently may be associated with a shorter modification period, whereas MIB content that remains static for longer durations may be assigned a longer modification period.

Different PBCH mapping types may be defined depending on whether gap symbols are present between PBCH symbols. Such gaps may be used, for example, to map secondary synchronization signals, or may arise due to waveform-specific transmission requirements. For instance, PBCH transmitted using discrete Fourier transform spread OFDM (DFT-s-OFDM) may require a different mapping type than PBCH transmitted using cyclic prefix OFDM (CP-OFDM).

Mapping Type A may apply when the PBCH is transmitted as part of a combined synchronization signal and PBCH block (i.e., an SS/PBCH block), and includes a gap OFDM symbol between PBCH symbols for the purpose of mapping secondary synchronization signals, e.g., in a 4 symbol SSB-PBCH symbols are mapped in symbols 2, 4, 5 while a second synchronization signal is mapped in symbol 3. In such configurations, the PBCH may be defined as having a non-contiguous mapping.

Mapping Type B may apply to standalone PBCH transmissions in which there are no gap symbols between PBCH symbols. In another implementation, Mapping Type B may also be associated with PBCH transmissions that utilize DFT-s-OFDM, or CP-OFDM or may represent a configuration that includes either or both of these criteria.

In one example, SS/PBCH block can be transmitted with a first periodicity within a first burst and synchronization signals without an associated PBCH can be transmitted with a second periodicity in a second burst. The candidate start locations of SS/PBCH symbols in a first burst and the candidate start locations of synchronization signals in a second burst can be preconfigured and provided to the UE.

In another example, a combination of PBCH mapping type A and type B can be implemented in a cell whereas SS/PBCH blocks in a burst based on mapping type A has one periodicity and standalone mapping type B has a second periodicity.

In 5G NR, the size of CORESET #0 may be 24 or 48 resource blocks (RBs) and may span 1-2 OFDM symbols in the time domain. For bandwidth-limited IoT devices, the CORESET #0 duration may be extended, for example to 5-6 OFDM symbols, in order to support higher aggregation levels necessary to meet deep coverage requirements for LPWA devices. Accordingly, CORESET #0 parameters may be configured separately for eMBB and LPWA devices using separate tables, as described herein.

The periodicity of the search space monitoring occasions for LPWA devices may be configured with a sparser schedule than that of eMBB devices. Furthermore, the CORESET #0 size for LPWA IoT devices may be restricted to 12 or 15 RBs to accommodate reduced bandwidth constraints.

The monitoring occasion for the common search space (CSS #0) physical downlink control channel (PDCCH) with respect to the SSB index may be separately configured.

The PDCCH monitoring for a Type0-PDCCH CSS set may be associated with SS/PBCH blocks and CORESET #0. In this context, the relevant configuration parameters may include the following:

For CORESET #0 transmission timing:

CORESET #0 may be transmitted in even-numbered radio frames when the following condition is satisfied: [(O·2μ+└i·M┘)/Nslotframe,μ] mod 2=0.

CORESET #0 may be transmitted in odd-numbered radio frames when: [(O·2μ+└i·M┘)/Nslotframe,μ] mod 2=1.

In these equations, O denotes the slot offset, i is the candidate SS/PBCH block index, M is a scaling factor, Nslotframe,μ is the number of slots in a radio frame for SCS configuration μ, and μ represents the numerology index (i.e., related to SCS).

For slot index for PDCCH monitoring:

The slot index n0n_0n0, at which the user equipment begins monitoring the PDCCH, may be computed as: n0=(O·2μ+└i·M┘) mod Nslotframe,μ

The UE may monitor two consecutive slots beginning from n0; namely, slots n0 and n0+1.

The value n0 thus represents the starting slot index within a radio frame at which the user equipment initiates PDCCH monitoring for the Type0-PDCCH CSS set associated with CORESET #0.

In practical terms, no determines the precise timing-expressed in slots within the radio frame when the user equipment should expect to detect CORESET #0, which carries the PDCCH.

In one implementation, the value of n0 may be differently defined for eMBB and LPWA devices.

Specifically, for LPWA devices, the formula used to calculate n0 may be extended to include a repetition index derived from the number of configured PDCCH repetitions. This may enable the LPWA device to monitor an increased number of PDCCH occasions to reliably receive system information blocks such as SIB0 or SIB1, relative to the configuration used for eMBB devices.

SIB0 may include, at a minimum, parameters related to cell selection and cell access, such as cell selection quality thresholds and public land mobile network (PLMN) identity. These parameters may be separately configured for eMBB and LPWA devices. Additionally, SIB0 for eMBB may support information related to emergency call functionality. Separate SIB0 configurations for eMBB and LPWA may include distinct user access control (UAC) barring mechanisms, tailored to the differing service requirements of each device type. In another implementation, certain parameters—such as PLMN identity, radio access network (RAN) area code, cell identity, and tracking area code—may be configured as common for both eMBB and IoT devices, while allowing the cell selection thresholds to be independently configured.

SIB1, which may contain resource configurations for RACH, paging, and related procedures, may also be separately configured based on the type of user equipment. For LPWA devices, SIB1 may be segmented into multiple code blocks due to bandwidth constraints, and the segments may be transmitted across multiple time slots. In another implementation, a lean SIB1 configuration may include common parameters shared by both eMBB and LPWA devices, such as serving cell common configuration, downlink cell common parameters, SSB-related information, and uplink-downlink time division duplex (TDD) configuration. The lean configuration may also specify how additional SIBs are transmitted on a device-type-specific basis. For example, a device-type-specific SIB-x configuration may define different RACH parameters, bandwidth parts (BWPs), and configurations for the physical uplink control channel (PUCCH) and physical uplink shared channel (PUSCH) for eMBB and IoT devices, respectively.

The original transmission of common channels may be configured using cyclic prefix orthogonal frequency-division multiplexing (CP-OFDM). However, additional repetitions of the common channels may be performed using low peak-to-average power ratio (PAPR) waveforms, such as discrete Fourier transform spread OFDM (DFT-s-OFDM), in order to provide extended downlink coverage.

When separate common channels are designed for eMBB and IoT devices, even within the common coverage area—such as where both device types operate under a MCL of approximately 145 dB—the base station may be required to transmit distinct common channels for each device type. This may lead to increased network power consumption. In one embodiment, a more efficient configuration may be achieved by defining a separate parameter set for common channels used exclusively in extended coverage scenarios. These scenarios may require a greater number of repetitions to meet target coverage requirements and may use a sparser transmission periodicity relative to the periodicity applied within the basic coverage area. The configuration for extended range may also utilize different CORESET #0 time-domain symbol allocations, reflecting the increased aggregation levels necessary for LPWA operation. Furthermore, the cell access quality thresholds defined in SIB0 may be separately configured for extended coverage, distinguishing them from the thresholds applied in the basic coverage region.

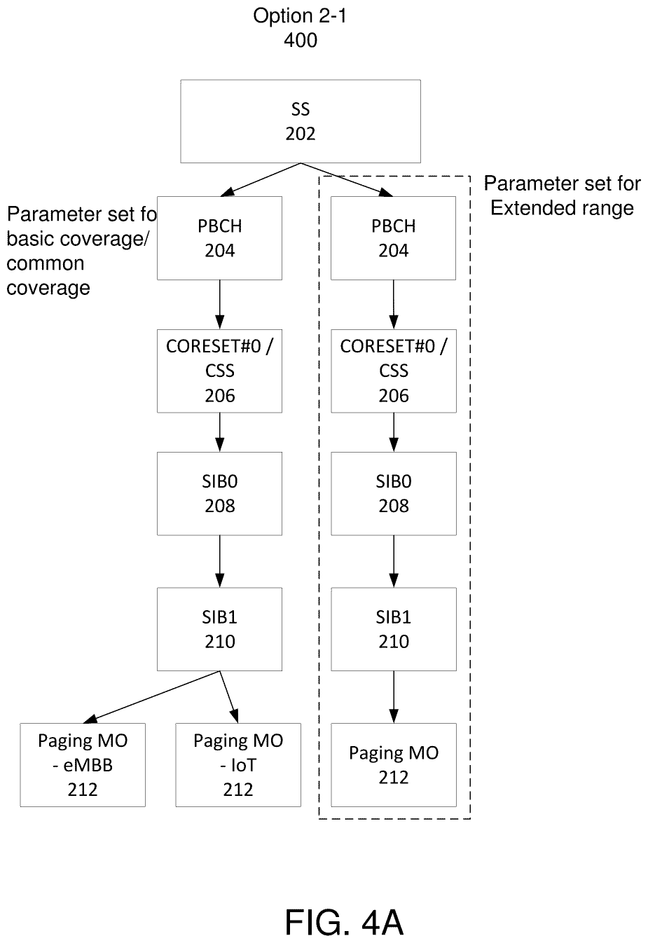

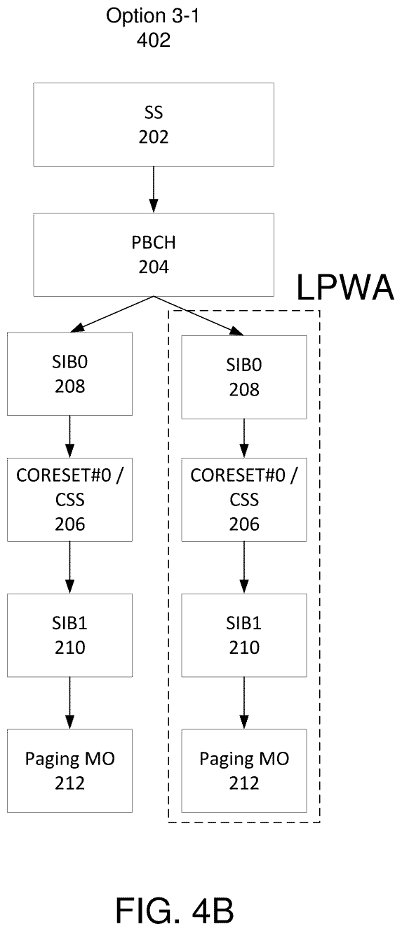

FIG. 4A depicts an example of configuring separate parameter sets for basic coverage and extended coverage, in accordance with aspects of the present disclosure. The Option 2-1 400 includes the SS 202, PBCH 204, CORESET #0/CSS 206, SIB0 208, SIB1 210, and paging MO 212.

A common parameter set may be applied to both eMBB and LPWA user equipment within the basic coverage area, which may be defined by a MCL of approximately 145 dB. This shared parameter set may include configurations for CORESET #0, SIB0, and SIB1. However, different paging monitoring occasions may be configured for each device type, reflecting the longer sleep period requirements of LPWA devices.

A second set of parameters may be configured specifically for extended coverage scenarios, such as those characterized by an MCL of approximately 164 dB. This extended coverage parameter set may support the reception of common channels—such as the PDCCH associated with CORESET #0, SIB0, SIB1, and paging—by LPWA devices.

One potential drawback of this dual-parameter approach is that the bandwidth of the common channels within the basic coverage area may need to be constrained to match the more limited bandwidth capabilities of LPWA device types. This constraint may also affect eMBB devices operating within the shared configuration.

Separate PBCHs may be associated with eMBB and LPWA devices. In such configurations, the MIB content transmitted using PBCH mapping type A may be transmitted together with the synchronization signal and may be commonly applicable to both eMBB and LPWA-IoT devices. In contrast, the MIB content transmitted using PBCH mapping type B—which corresponds to a standalone PBCH transmission—may be specifically associated with LPWA-IoT devices.

FIG. 4B depicts an example of an initial access procedure with a SIB0 scheduled by PBCH, in accordance with aspects of the present disclosure. The Option 3-1 402 includes the SS 202, PBCH 204, SIB0 208, CORESET #0/CSS 206, SIB1 210, and paging MO 212.

In one embodiment, a PBCH of a cell may carry information identifying the time and frequency resources of a physical downlink shared channel (PDSCH) that transmits SIB0 for that cell. The SIB0 may include information such as the configuration of CORESET #0 and common search space (CSS #0), cell selection parameters, and cell access-related information. However, SIB0 may not include a full serving cell configuration or system information (SI) scheduling details. For each service or device type (e.g., eMBB, LPWA), a predefined set of time and frequency resources and corresponding DMRS configurations for the PDSCH carrying SIB0 may be established. The MIB and/or PBCH payload may include an indicator referencing one of these predefined time-frequency resources and its corresponding DMRS configuration.

In one implementation, the indicator included in the MIB and/or PBCH payload may refer to different tables, each comprising a different set of time and frequency resources and DMRS configurations. A first table may be defined for eMBB devices and a second table for LPWA-IoT devices.

In another implementation, a single table may be used in which each row includes two sets of time and frequency resources and corresponding DMRS configurations—one set for eMBB and the other for LPWA-IoT devices.

FIG. 4B illustrates an example of an initial access procedure for eMBB and LPWA-IoT user equipment in which SIB0 is scheduled via the PBCH. With separate SIB0 configurations for eMBB and LPWA-IoT, each SIB0 instance may be configured with a CORESET #0 and CSS #0 appropriate for the respective device or service type.

In one example, the MIB may carry the following information, which may be common to both 6G eMBB and LPWA-IoT devices: cell barring information (e.g., 2 bits), indicating whether the cell is: barred for both eMBB and LPWA-IoT; barred for eMBB only; barred for LPWA-IoT only or not barred; intra-frequency reselection parameters; SSB-subcarrier offset, representing the frequency domain offset between the SSB and the overall resource block grid, expressed in number of subcarriers; subcarrier spacing applicable to common channels, such as for SIB1, message 2/4 in the initial access procedure, paging, and broadcast SI-messages; system frame number; and/or SIB0 scheduling information (e.g., 4 bits), indicating the selected time and frequency resource and associated DMRS configuration for the PDSCH carrying SIB0.

In SIB0, at least the following information may be included: CORESET #0 configuration; common search space #0 configuration; PDSCH DMRS configuration; and/or HFN (included only in the SIB0 for LPWA-IoT devices). In some examples, there can be a time offset to the SIB0 location from the PBCH which can be preconfigured in the specification or maybe indicated in the PBCH. The beam index or part of beam index that is assigned a unique index within a burst to transmit SIB0 or SSB block index within a SSB burst period can be provided to the UE as a payload via SIB0. In another example, SIB0 may carry an entire beam index for lower frequency range or a second part of the beam index for the higher frequency range where the number of beams are more, whereas the first part of the beam index maybe transmitted in the PBCH or PBCH DMRS.

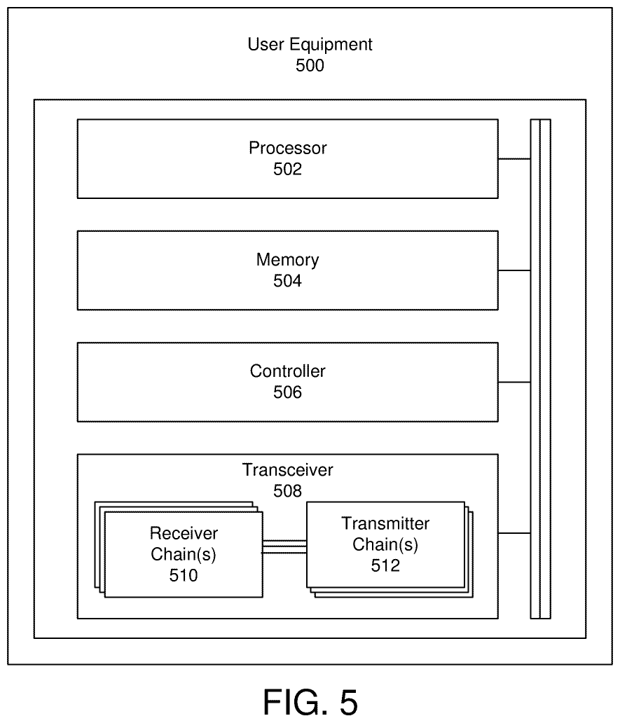

FIG. 5 illustrates an example of a UE 500 in accordance with aspects of the present disclosure. The UE 500 may include a processor 502, a memory 504, a controller 506, and a transceiver 508. The processor 502, the memory 504, the controller 506, or the transceiver 508, or various combinations thereof or various components thereof may be examples of means for performing various aspects of the present disclosure as described herein. These components may be coupled (e.g., operatively, communicatively, functionally, electronically, electrically) via one or more interfaces.

The processor 502, the memory 504, the controller 506, or the transceiver 508, or various combinations or components thereof may be implemented in hardware (e.g., circuitry). The hardware may include a processor, a digital signal processor (DSP), an application-specific integrated circuit (ASIC), or other programmable logic device, or any combination thereof configured as or otherwise supporting a means for performing the functions described in the present disclosure.

The processor 502 may include an intelligent hardware device (e.g., a general-purpose processor, a DSP, a central processing unit (CPU), an ASIC, a field programmable gate array (FPGA), or any combination thereof). In some implementations, the processor 502 may be configured to operate the memory 504. In some other implementations, the memory 504 may be integrated into the processor 502. The processor 502 may be configured to execute computer-readable instructions stored in the memory 504 to cause the UE 500 to perform various functions of the present disclosure.

The memory 504 may include volatile or non-volatile memory. The memory 504 may store computer-readable, computer-executable code including instructions that, when executed by the processor 502, cause the UE 500 to perform various functions described herein. The code may be stored in a non-transitory computer-readable medium such the memory 504 or another type of memory. Computer-readable media includes both non-transitory computer storage media and communication media including any medium that facilitates transfer of a computer program from one place to another. A non-transitory storage medium may be any available medium that may be accessed by a general-purpose or special-purpose computer.

In some implementations, the processor 502 and the memory 504 coupled with the processor 502 may be configured to cause the UE 500 to perform one or more of the UE functions described herein (e.g., executing, by the processor 502, instructions stored in the memory 504). Accordingly, the processor 502 may support wireless communication at the UE 500 in accordance with examples as disclosed herein.

In one example, the UE 500 is configured to receive, as part of an initial access procedure, configuration information comprising a common channel that supports a plurality of device types and a device type common channel for a device type of the plurality of device types, wherein the plurality of device types comprises a first device type that supports MBB communication and a second device type that supports an IoT communication, receive, in the common channel, a first portion of RMSI that is common for the plurality of device types, and receive, in the device type common channel, a second portion of the RMSI and paging information that is specific to the device type.

The controller 506 may manage input and output signals for the UE 500. The controller 506 may also manage peripherals not integrated into the UE 500. In some implementations, the controller 506 may utilize an operating system (OS) such as iOS®, ANDROID®, WINDOWS®, or other operating systems. In some implementations, the controller 506 may be implemented as part of the processor 502.

In some implementations, the UE 500 may include at least one transceiver 508. In some other implementations, the UE 500 may have more than one transceiver 508. The transceiver 508 may represent a wireless transceiver. The transceiver 508 may include one or more receiver chains 510, one or more transmitter chains 512, or a combination thereof.

A receiver chain 510 may be configured to receive signals (e.g., control information, data, packets) over a wireless medium. For example, the receiver chain 510 may include one or more antennas for receiving the signal over the air or wireless medium. The receiver chain 510 may include at least one amplifier (e.g., a low-noise amplifier (LNA)) configured to amplify the received signal. The receiver chain 510 may include at least one demodulator configured to demodulate the received signal and obtain the transmitted data by reversing the modulation technique applied during transmission of the signal. The receiver chain 510 may include at least one decoder for decoding/processing the demodulated signal to receive the transmitted data.

A transmitter chain 512 may be configured to generate and transmit signals (e.g., control information, data, packets). The transmitter chain 512 may include at least one modulator for modulating data onto a carrier signal, preparing the signal for transmission over a wireless medium. The at least one modulator may be configured to support one or more techniques such as amplitude modulation (AM), frequency modulation (FM), or digital modulation schemes like phase-shift keying (PSK) or quadrature amplitude modulation (QAM). The transmitter chain 512 may also include at least one power amplifier configured to amplify the modulated signal to an appropriate power level suitable for transmission over the wireless medium. The transmitter chain 512 may also include one or more antennas for transmitting the amplified signal into the air or wireless medium.

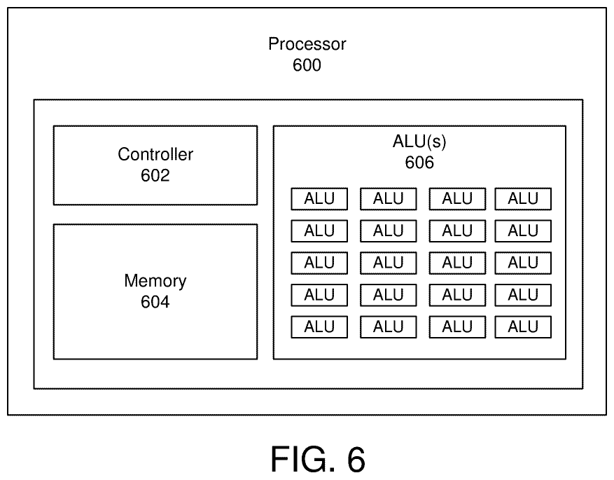

FIG. 6 illustrates an example of a processor 600 in accordance with aspects of the present disclosure. The processor 600 may be an example of a processor configured to perform various operations in accordance with examples as described herein. The processor 600 may include a controller 602 configured to perform various operations in accordance with examples as described herein. The processor 600 may optionally include at least one memory 604, which may be, for example, an L1/L2/L3 cache. Additionally, or alternatively, the processor 600 may optionally include one or more arithmetic-logic units (ALUs) 606. One or more of these components may be in electronic communication or otherwise coupled (e.g., operatively, communicatively, functionally, electronically, electrically) via one or more interfaces (e.g., buses).

The processor 600 may be a processor chipset and include a protocol stack (e.g., a software stack) executed by the processor chipset to perform various operations (e.g., receiving, obtaining, retrieving, transmitting, outputting, forwarding, storing, determining, identifying, accessing, writing, reading) in accordance with examples as described herein. The processor chipset may include one or more cores, one or more caches (e.g., memory local to or included in the processor chipset (e.g., the processor 600) or other memory (e.g., random access memory (RAM), read-only memory (ROM), dynamic RAM (DRAM), synchronous dynamic RAM (SDRAM), static RAM (SRAM), ferroelectric RAM (FeRAM), magnetic RAM (MRAM), resistive RAM (RRAM), flash memory, phase change memory (PCM), and others).

The controller 602 may be configured to manage and coordinate various operations (e.g., signaling, receiving, obtaining, retrieving, transmitting, outputting, forwarding, storing, determining, identifying, accessing, writing, reading) of the processor 600 to cause the processor 600 to support various operations in accordance with examples as described herein. For example, the controller 602 may operate as a control unit of the processor 600, generating control signals that manage the operation of various components of the processor 600. These control signals include enabling or disabling functional units, selecting data paths, initiating memory access, and coordinating timing of operations.

The controller 602 may be configured to fetch (e.g., obtain, retrieve, receive) instructions from the memory 604 and determine subsequent instruction(s) to be executed to cause the processor 600 to support various operations in accordance with examples as described herein. The controller 602 may be configured to track memory address of instructions associated with the memory 604. The controller 602 may be configured to decode instructions to determine the operation to be performed and the operands involved. For example, the controller 602 may be configured to interpret the instruction and determine control signals to be output to other components of the processor 600 to cause the processor 600 to support various operations in accordance with examples as described herein. Additionally, or alternatively, the controller 602 may be configured to manage flow of data within the processor 600. The controller 602 may be configured to control transfer of data between registers, arithmetic logic units (ALUs), and other functional units of the processor 600.

The memory 604 may include one or more caches (e.g., memory local to or included in the processor 600 or other memory, such RAM, ROM, DRAM, SDRAM, SRAM, MRAM, flash memory, etc. In some implementations, the memory 604 may reside within or on a processor chipset (e.g., local to the processor 600). In some other implementations, the memory 604 may reside external to the processor chipset (e.g., remote to the processor 600).

The memory 604 may store computer-readable, computer-executable code including instructions that, when executed by the processor 600, cause the processor 600 to perform various functions described herein. The code may be stored in a non-transitory computer-readable medium such as system memory or another type of memory. The controller 602 and/or the processor 600 may be configured to execute computer-readable instructions stored in the memory 604 to cause the processor 600 to perform various functions. For example, the processor 600 and/or the controller 602 may be coupled with or to the memory 604, the processor 600, the controller 602, and the memory 604 may be configured to perform various functions described herein. In some examples, the processor 600 may include multiple processors and the memory 604 may include multiple memories. One or more of the multiple processors may be coupled with one or more of the multiple memories, which may, individually or collectively, be configured to perform various functions herein.

The one or more ALUs 606 may be configured to support various operations in accordance with examples as described herein. In some implementations, the one or more ALUs 606 may reside within or on a processor chipset (e.g., the processor 600). In some other implementations, the one or more ALUs 606 may reside external to the processor chipset (e.g., the processor 600). One or more ALUs 606 may perform one or more computations such as addition, subtraction, multiplication, and division on data. For example, one or more ALUs 606 may receive input operands and an operation code, which determines an operation to be executed. One or more ALUs 606 be configured with a variety of logical and arithmetic circuits, including adders, subtractors, shifters, and logic gates, to process and manipulate the data according to the operation. Additionally, or alternatively, the one or more ALUs 606 may support logical operations such as AND, OR, exclusive-OR (XOR), not-OR (NOR), and not-AND (NAND), enabling the one or more ALUs 606 to handle conditional operations, comparisons, and bitwise operations.

In various examples, the processor 600 may support wireless communication of a UE, in accordance with examples as disclosed herein. In other examples, the processor 600 may support wireless communication of a RAN entity, in accordance with examples as disclosed herein.

In one example, a processor 600 is configured to receive, as part of an initial access procedure, configuration information comprising a common channel that supports a plurality of device types and a device type common channel for a device type of the plurality of device types, wherein the plurality of device types comprises a first device type that supports MBB communication and a second device type that supports an IoT communication, receive, in the common channel, a first portion of RMSI that is common for the plurality of device types, and receive, in the device type common channel, a second portion of the RMSI and paging information that is specific to the device type.

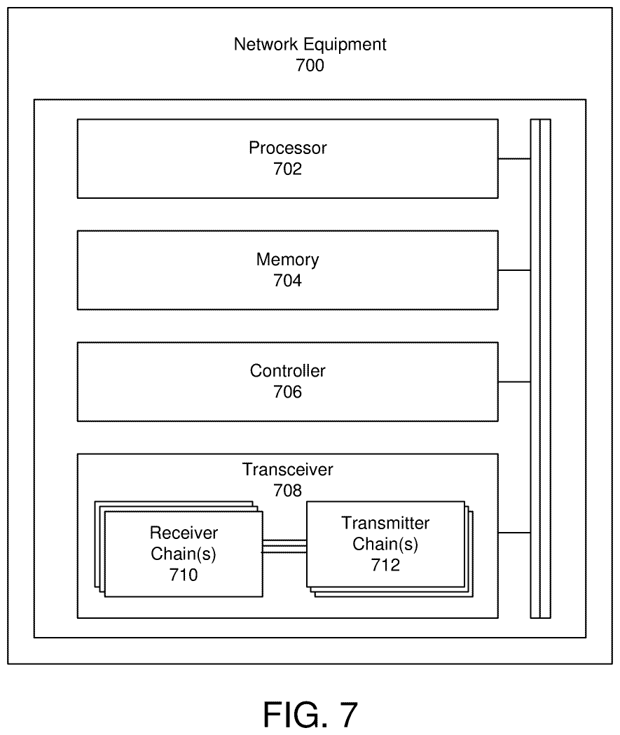

FIG. 7 illustrates an example of a NE 700 in accordance with aspects of the present disclosure. The NE 700 may include a processor 702, a memory 704, a controller 706, and a transceiver 708. The processor 702, the memory 704, the controller 706, or the transceiver 708, or various combinations thereof or various components thereof may be examples of means for performing various aspects of the present disclosure as described herein. These components may be coupled (e.g., operatively, communicatively, functionally, electronically, electrically) via one or more interfaces.

The processor 702, the memory 704, the controller 706, or the transceiver 708, or various combinations or components thereof may be implemented in hardware (e.g., circuitry). The hardware may include a processor, a digital signal processor (DSP), an application-specific integrated circuit (ASIC), or other programmable logic device, or any combination thereof configured as or otherwise supporting a means for performing the functions described in the present disclosure.

The processor 702 may include an intelligent hardware device (e.g., a general-purpose processor, a DSP, a CPU, an ASIC, an FPGA, or any combination thereof). In some implementations, the processor 702 may be configured to operate the memory 704. In some other implementations, the memory 704 may be integrated into the processor 702. The processor 702 may be configured to execute computer-readable instructions stored in the memory 704 to cause the NE 700 to perform various functions of the present disclosure.

The memory 704 may include volatile or non-volatile memory. The memory 704 may store computer-readable, computer-executable code including instructions when executed by the processor 702 cause the NE 700 to perform various functions described herein. The code may be stored in a non-transitory computer-readable medium such the memory 704 or another type of memory. Computer-readable media includes both non-transitory computer storage media and communication media including any medium that facilitates transfer of a computer program from one place to another. A non-transitory storage medium may be any available medium that may be accessed by a general-purpose or special-purpose computer.

In some implementations, the processor 702 and the memory 704 coupled with the processor 702 may be configured to cause the NE 700 to perform one or more of the RAN functions described herein (e.g., executing, by the processor 702, instructions stored in the memory 704). For example, the processor 702 may support wireless communication at the NE 700 in accordance with examples as disclosed herein.

In one example, a NE 700 is configured to configure, as part of an initial access procedure, a common channel that supports a plurality of device types and a device type common channel for a device type of the plurality of device types, wherein the plurality of device types comprises a first device type that supports MBB communication and a second device type that supports an IoT communication, transmit, in the common channel, a first portion of RMSI that is common for the plurality of device types, and transmit, in the device type common channel, a second portion of the RMSI and paging information that is specific to the device type.

The controller 706 may manage input and output signals for the NE 700. The controller 706 may also manage peripherals not integrated into the NE 700. In some implementations, the controller 706 may utilize an operating system such as iOS®, ANDROID®, WINDOWS®, or other operating systems. In some implementations, the controller 706 may be implemented as part of the processor 702.

In some implementations, the NE 700 may include at least one transceiver 708. In some other implementations, the NE 700 may have more than one transceiver 708. The transceiver 708 may represent a wireless transceiver. The transceiver 708 may include one or more receiver chains 710, one or more transmitter chains 712, or a combination thereof.

A receiver chain 710 may be configured to receive signals (e.g., control information, data, packets) over a wireless medium. For example, the receiver chain 710 may include one or more antennas for receiving the signal over the air or wireless medium. The receiver chain 710 may include at least one amplifier (e.g., a low-noise amplifier (LNA)) configured to amplify the received signal. The receiver chain 710 may include at least one demodulator configured to demodulate the received signal and obtain the transmitted data by reversing the modulation technique applied during transmission of the signal. The receiver chain 710 may include at least one decoder for decoding/processing the demodulated signal to receive the transmitted data.

A transmitter chain 712 may be configured to generate and transmit signals (e.g., control information, data, packets). The transmitter chain 712 may include at least one modulator for modulating data onto a carrier signal, preparing the signal for transmission over a wireless medium. The at least one modulator may be configured to support one or more techniques such as amplitude modulation (AM), frequency modulation (FM), or digital modulation schemes like phase-shift keying (PSK) or quadrature amplitude modulation (QAM). The transmitter chain 712 may also include at least one power amplifier configured to amplify the modulated signal to an appropriate power level suitable for transmission over the wireless medium. The transmitter chain 712 may also include one or more antennas for transmitting the amplified signal into the air or wireless medium.

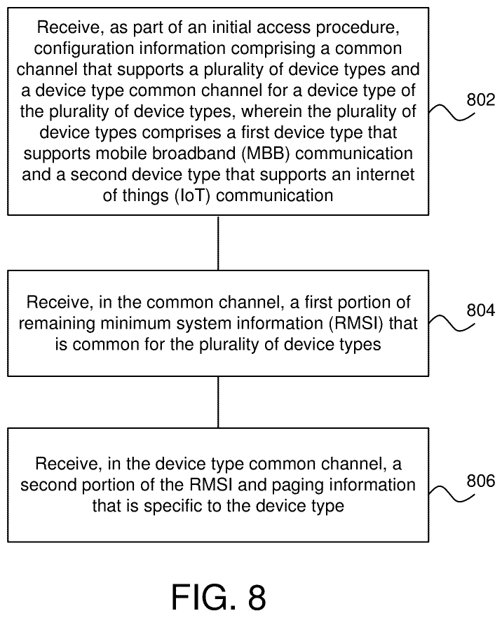

FIG. 8 illustrates a flowchart of a method performed by a UE 500 in accordance with aspects of the present disclosure. The operations of the method may be implemented by a UE 500 as described herein. In some implementations, the UE 500 may execute a set of instructions to control the function elements of the UE 500 to perform the described functions.

At step 802, the method may receive, as part of an initial access procedure, configuration information comprising a common channel that supports a plurality of device types and a device type common channel for a device type of the plurality of device types, wherein the plurality of device types comprises a first device type that supports MBB communication and a second device type that supports an IoT communication. The operations of step 802 may be performed in accordance with examples as described herein. In some implementations, aspects of the operations of step 802 may be performed by a UE 500, as described with reference to FIG. 5.

At step 804, the method may receive, in the common channel, a first portion of RMSI that is common for the plurality of device types. The operations of step 804 may be performed in accordance with examples as described herein. In some implementations, aspects of the operations of step 804 may be performed by a UE 500, as described with reference to FIG. 5.

At step 806, the method may receive, in the device type common channel, a second portion of the RMSI and paging information that is specific to the device type. The operations of step 806 may be performed in accordance with examples as described herein. In some implementations, aspects of the operations of step 806 may be performed by a UE 500, as described with reference to FIG. 5.

It should be noted that the method described herein describes one possible implementation, and that the operations and the steps may be rearranged or otherwise modified and that other implementations are possible.

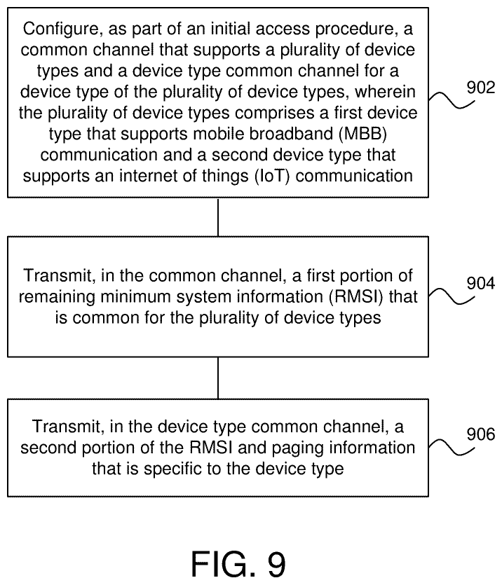

FIG. 9 illustrates a flowchart of a method performed by an NE 700 in accordance with aspects of the present disclosure. The operations of the method may be implemented by a NE 700 as described herein. In some implementations, the NE 700 may execute a set of instructions to control the function elements of the NE 700 to perform the described functions.

At step 902, the method may configure, as part of an initial access procedure, a common channel that supports a plurality of device types and a device type common channel for a device type of the plurality of device types, wherein the plurality of device types comprises a first device type that supports MBB communication and a second device type that supports an IoT communication. The operations of step 902 may be performed in accordance with examples as described herein. In some implementations, aspects of the operations of step 902 may be performed by a NE 700, as described with reference to FIG. 7.

At step 904, the method may transmit, in the common channel, a first portion of RMSI that is common for the plurality of device types. The operations of step 904 may be performed in accordance with examples as described herein. In some implementations, aspects of the operations of step 904 may be performed by a NE 700, as described with reference to FIG. 7.

At step 906, the method may transmit, in the device type common channel, a second portion of the RMSI and paging information that is specific to the device type. The operations of step 906 may be performed in accordance with examples as described herein. In some implementations, aspects of the operations of step 906 may be performed by a NE 700, as described with reference to FIG. 7.

It should be noted that the method described herein describes one possible implementation, and that the operations and the steps may be rearranged or otherwise modified and that other implementations are possible.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A base station, comprising:
at least one memory; and
at least one processor coupled with the at least one memory and configured to cause the base station to:
configure, as part of an initial access procedure, a common channel that supports a plurality of device types and a device type common channel for a device type of the plurality of device types, wherein the plurality of device types comprises a first device type that supports mobile broadband (MBB) communication and a second device type that supports an internet of things (IoT) communication;
transmit, in the common channel, a first portion of remaining minimum system information (RMSI) that is common for the plurality of device types; and
transmit, in the device type common channel, a second portion of the RMSI and paging information that is specific to the device type.

2. The base station of claim 1, wherein the at least one processor is configured to cause the base station to transmit control resource set (CORESET) information and common search space (CSS) information using a table.

3. The base station of claim 2, wherein the CORESET information and the CSS information define a time-frequency location of one or more of a first CORESET, or physical downlink control channel (PDCCH) monitoring occasions for RMSI delivery.

4. The base station of claim 2, wherein the CORESET information and the CSS information each comprise a first entry in the table corresponding to the first device type and a second entry in the table corresponding to the second device type.

5. The base station of claim 1, wherein the at least one processor is configured to cause the base station to perform physical broadcast channel (PBCH) repetition using a number of synchronization signal (SS)/PBCH transmissions based on a first mapping type and periodic on-demand standalone PBCH repetition using a second mapping.

6. The base station of claim 5, wherein the first mapping type comprises a non-contiguous PBCH mapping and the second mapping type comprises a contiguous PBCH mapping.

7. The base station of claim 1, wherein the second portion of the RMSI comprises a device specific system information block (SIB) comprising a cell selection quality threshold for the device type.

8. A user equipment (UE), comprising:
at least one memory; and
at least one processor coupled with the at least one memory and configured to cause the UE to:
receive, as part of an initial access procedure, configuration information comprising a common channel that supports a plurality of device types and a device type common channel for a device type of the plurality of device types, wherein the plurality of device types comprises a first device type that supports mobile broadband (MBB) communication and a second device type that supports an internet of things (IoT) communication;
receive, in the common channel, a first portion of remaining minimum system information (RMSI) that is common for the plurality of device types; and
receive, in the device type common channel, a second portion of the RMSI and paging information that is specific to the device type.

9. The UE of claim 8, wherein the at least one processor is configured to cause the UE to receive control resource set (CORESET) information and common search space (CSS) information using a table.

10. The UE of claim 9, wherein the CORESET information and the CSS information define a time-frequency location of one or more of a first CORESET, or physical downlink control channel (PDCCH) monitoring occasions for RMSI delivery.

11. The UE of claim 9, wherein the CORESET information and the CSS information each comprise a first entry in the table corresponding to the first device type and a second entry in the table corresponding to the second device type.

12. The UE of claim 8, wherein the at least one processor is configured to cause the UE to receive physical broadcast channel (PBCH) repetition using a number of synchronization signal (SS)/PBCH transmissions based on a first mapping type and periodic on-demand standalone PBCH repetition using a second mapping.

13. The UE of claim 12, wherein the first mapping type comprises a non-contiguous PBCH mapping and the second mapping type comprises a contiguous PBCH mapping.

14. The UE of claim 11, wherein the second portion of the RMSI comprises a device specific system information block (SIB) comprising a cell selection quality threshold for the device type.

15. A processor for wireless communication, comprising:
at least one controller coupled with at least one memory and configured to cause the processor to:
receive, as part of an initial access procedure, configuration information comprising a common channel that supports a plurality of device types and a device type common channel for a device type of the plurality of device types, wherein the plurality of device types comprises a first device type that supports mobile broadband (MBB) communication and a second device type that supports an internet of things (IoT) communication;
receive, in the common channel, a first portion of remaining minimum system information (RMSI) that is common for the plurality of device types; and
receive, in the device type common channel, a second portion of the RMSI and paging information that is specific to the device type.

16. A method performed by a user equipment (UE), the method comprising:
receiving, as part of an initial access procedure, configuration information comprising a common channel that supports a plurality of device types and a device type common channel for a device type of the plurality of device types, wherein the plurality of device types comprises a first device type that supports mobile broadband (MBB) communication and a second device type that supports an internet of things (IoT) communication;
receiving, in the common channel, a first portion of remaining minimum system information (RMSI) that is common for the plurality of device types; and
receiving, in the device type common channel, a second portion of the RMSI and paging information that is specific to the device type.

17. The method of claim 16, further comprising receiving control resource set (CORESET) information and common search space (CSS) information using a table.

18. The method of claim 17, wherein the CORESET information and the CSS information define a time-frequency location of one or more of a first CORESET, or physical downlink control channel (PDCCH) monitoring occasions for RMSI delivery.

19. The method of claim 17, wherein the CORESET information and the CSS information each comprise a first entry in the table corresponding to the first device type and a second entry in the table corresponding to the second device type.

20. The method of claim 16, further comprising receiving physical broadcast channel (PBCH) repetition using a number of synchronization signal (SS)/PBCH transmissions based on a first mapping type and periodic on-demand standalone PBCH repetition using a second mapping.
